(19) United States
(12) Patent Application Publication
(10) Pub. No.: US 2020/0056132 A1
(43) Pub. Date: Feb. 20, 2020

(54) SOLID NON-REACTIVE PARTICLE INCLUSIONS TO ACCELERATE AGING IN WINE OR SPIRITS

(71) Applicant: James E. Spooner, Albuquerque, NM (US)

(72) Inventor: James E. Spooner, Albuquerque, NM (US)

(21) Appl. No.: 16/104,895

(22) Filed: Aug. 18, 2018

(51) Int. Cl. C12H 1/22; C12H 1/14; C12G 1/00; C12G 3/08

(52) U.S. Cl. CPC C12H 1/22; C12G 3/08; C12G 1/00; C12H 1/14

(57) ABSTRACT

This invention addresses the treatment of wine in bulk and spirits in casks to provide a means for accelerating the desired effects of aging in a foreshortened time period. This treatment is comprised small solid non-reactive inclusions, named SRI by the inventor, that demonstrate geometrical properties that result in many small radii of curvature deformations in the surrounding liquid. The resulting high geometrical curvature of these multitudinous cavities will act to increase available energy at the interface and thus accelerate the native chemical reactions in the surrounding liquid to produce aging effects in a foreshortened time period. Examples of SRI are crushed glass, stainless steel wool and fiberglass.

### RELATED APPLICATION

The inventor claims the benefit of the filing date for related Provisional Patent 62/546,681 filed on Aug. 17, 2017.

### FIELD OF THE INVENTION

The present invention relates to acceleration of native chemical reactions in wines and spirits in the presence of non-reactive solid inclusions.

### REFERENCES

1. M. A. Amerine and M. A, Joslyn, Table Wines, University of California Press, 1951.
2. Singleton V. 1962. Aging Of Wines And Other Spiritous Products, Acceleration By Physical Treatments. Hilgardia 32(7).
3. Pat. App No., 20180051240, Frequency Conversion Ultrasonic Wine Aging Device.
4. Pat. App No. 20100288130, Apparatus for Aging Wine or Spirits.
5. U.S. Pat. No. 3,942,423, Device for Accelerated Aging of Wine.
6. U.S. Pat. No. 7,762,179, System for Non-Deleterious Accelerated Aging of Wine Or Spirits

### BACKGROUND OF THE INVENTION

The production of still wine, i.e., no residual carbonation, is summarized by the inventor based on a description by Amerine (1) as 7 Stages:
1. Harvesting the grapes,
2. Crushing the grapes and separating the stems to produce a must of skins, seeds, pulp and juice,
3. Pumping the must to a fermentation tank where yeast is added and fermentation lasts for several months,
4. Pumping to a pomace press where the solids are separated from the fermenting wine,
5. Recycle the pomace (solids) to the vineyard and pump the rough wine to a settling tank for a few weeks to a few months to complete fermentation,
6. Pumping the new wine through a filter to a finishing and holding tank for approximately six to nine months while the fermentation of the remaining sugar is complete and fermentation products are separated (clarified) prior to bottling, There can be times when the young wine is place placed in oak barrels for extended aging rather than directly to bottling.
7. Pumping the clarified new wine through a filter to the bottling line where introduction into individual bottles and finishing with a cork or cap closure takes place.

Under normal procedures the time spent in Stage 6 can be characterized as aging, but the amount is vanishingly small because the 6 to 9 months is not considered significant for this purpose. Only in Stage 7 when the wine is confined to bottles is aging considered to be possible. Traditionally this will occur when corked bottles are laid down for a prolonged time of at least a year and more likely several years. There are instances when high quality bottles have been laid down for decades with beneficial results. Capped bottles are not considered suitable for prolonged aging most likely due to higher oxygen transfer.

Even though Reference (2) is older, 1962, Singleton has always been considered a reliable and prolific source related to wine aging. In this reference he summarizes many different ways to accomplish acceleration of the native chemical processes associated with wine. The deliberate intent to set aside wine for aging he surmises was begun over 2000 years ago. He describes the sensory effects of aging as: “ . . . mellowing, rounding, increasing harmoniousness, decreasing harshness, softening, increasing complexity, and adding flavor nuances.” Obviously, these descriptions sound very subjective, but it is not difficult for a professional taster to detect these subtle changes.

The Patent in Reference (3), U.S. Patent Application 20180051240, describes a rather harsh treatment with ultrasound that may result in chemical changes, but Singleton in Reference (2) describes similar attempts where the results were far from pleasant.

The patent device of Reference (4), U.S. Patent Application 20100288130, provides an increased rate of oxygenation which may be acceptable in an alcoholic wine like sherry or port, 20%, where a rancio flavor and aroma is desirable, but not in a still wine of alcoholic content 12-14%.

U.S. Pat. No. 3,942,423, Reference (5), describes a device to increase both the oxygenation and the transfer of oak wood character to the wine at an accelerated rate. This can easily result in extreme and undesirable modifications in both.

U.S. Pat. No. 7,762,179, Reference (6), describes a device for agitating the contents of a barrel. This may increase the reaction with any available oxygen, but is not necessarily good for the production of subtle flavor changes.

### BRIEF SUMMARY OF THE INVENTION

The following disclosure relates to the acceleration of native chemical reactions in Stage 6 of vinification above, in the presence of non-reactive solid inclusions in a passive state that requires little to no agitation. These solid inclusions are characterized by sharp edges, points and small size. The sharp edges are like those found with a knife edge, or broken glass. A point is like a needle point. Small sizes can be characterized by the diameter of a glass fiber or a small grain of sand. As a convenience, the inventor has named this generic class of solids as SRI for “small radius inclusions”.

### DRAWINGS

Not applicable.

### DETAIL DESCRIPTION OF THE INVENTION

SRI does not have a particular geometry, but has at least one characteristic dimension that is small. “Small radius” can refer to one or more instances on the same particle; thus, a thistle like structure will have multiple needle points on one particle. SRI can also be a small spherical bead or a long small diameter fiber or a piece of crushed glass.

SRI does not have a particular geometry but has at least one surface feature that will produce a void in the surrounding liquid that exhibits a small radius of curvature or high geometrical curvature at the interface to the surrounding medium. Thus, a small spherical bead or a long small diameter piece of fiberglass or a piece of crushed glass with many sharp edges or a needle point, or a small thistle-like structure with multiple points will qualify as SRI. The effect of SRI is to produce cavities with a high geometrical curvature in the surrounding liquid medium that will result in an increased surface energy at the interface that modifies the rate of change of the native reaction in the wine. A single particle of SRI may not have a small overall dimension but may exhibit sharp edges and/or points that will produce a high geometrical curvature somewhere on the surface. A larger piece of crushed glass with many sharp edges is an example.

The complex considered here is a two-phase composition of a reactive medium and non-reactive SRI. In its simplest form, the SRI will be solids that exhibit no chemical interaction with a chemically active wine. Without SRI particulate inclusions, the native reaction rate in the medium is a baseline. The inclusion of SRI in the reactive wine medium creates cavities within the medium. The smaller the dimension of that cavity, the higher the geometrical curvature will be resulting in a higher surface energy at the interface. The increase in surface energy produced by the SRI results in additional energy that will be available for the ongoing native chemical reactions. This, in turn, results in an increased chemical reaction rate, albeit in wine these reactions are quite slow. This increase in reaction rate is based upon the introduction of small radius geometrical cavities created by the SRI within the volume of the wine. The increase may not be large with respect to the very slow baseline and may need a large number of particles as well as a significant time to elapse for any change in rate to be observable.

The background for this concept originated with an experiment performed by the Inventor related to the rapid aging of wine.

### SUMMARY OF EXPERIMENT

### Introduction

This experiment relates to acceleration of reaction rates adjacent to unreactive crushed glass characterized by sharp edges immersed in wine.

Wine when first bottled, especially with a solid cork closure, will have a pressurized headspace filled with air, i.e. 79% nitrogen and 21% oxygen unless the headspace is first purged with a more desirable gas such as nitrogen or argon. However, it is expected that even if oxygen is present, it will react with components of the wine such as tannins leaving a headspace composed of essentially nitrogen that is unreactive with the wine. The subsequent chemical environment in the bottle is chemically reducing. Some wine scientists believe that the miniscule amount of oxygen that may penetrate the cork is instrumental in aging. This inventor is persuaded that the amount of oxygen is vanishingly small and plays essentially no part in the aging process. Only the slow reactions among the native chemicals: alcohol, acids, phenols, sugars, tannins, esters and anthocyanins will continue to interact over a long period of time that can be measured in years and even decades. The end result is an increase in an attractive complexity of both aroma and taste that is characteristic of aging. The inventor claims that the presence of SRI accelerates that process and also can occur in bulk during the vinification process as well as the bottle.

This experiment used the sharp edges found with crushed unreactive glass to modify the chemical reactions associated with the aging process. The inventors's expectation was that the products of this acceleration would produce results that would enhance the native reactions and lead to an attractive modification in a foreshortened time period.

### EXPERIMENT

A. Summary
Four pairs of inexpensive wines, three red and one white, were treated with 10 gm. of 2 mm ASTM sieve size crushed glass in each 750 ml. bottle and tasted over several months to see if there were any notable organoleptic changes. The bottles were stored in a closet on a tiled concrete floor so the temperature was a steady at 70 even during the summer. Not the classical temperature for aging of 55 degrees, but the temperature was expected to accelerate any observable effect. Samples were taken for tasting at 1, 3, 6 and 9 months.

B. Results
The wines were tasted four times over a 9-month period. In the early tastings, there was little indication of changes other than a reduction of bitterness, but later there was indication of differences between the treated and untreated wine. At the end of the nine months, although the absolute results were not dramatic, there was noticeable evidence that there was improvement in taste and aroma for the treated wines, that is, less bitterness, fuller body and more complexity.

C. Conclusion
It is apparent that the crushed glass SRI not only produces reaction products in the wine in just six months time, but the organoleptic results are also positive. The products of this process may not be identical to those produced by conventional aging over a longer time period, but because the results appear positive, it still can be a desirable process for treating less expensive wines, especially if applied in the early stages of vinification in bulk as in stages 7 described earlier. However, I suspect that the products are essentially the same as found with traditionally aged wines. The inventor's thinking is that the processes are not accelerated enough to alter the nature of the resultant products.
   Although this experiment was done on finished wine in bottles, there is no reason to believe the process would not be just as effective and certainly more financially attractive in bulk vinification. This would take place in the final large tank before filtering and bottling as described by Amerine (1).

The use of crushed glass would appear to be undesirable for use with a food like wine, however, the settling and filtration that occurs at Stages 6 does color that conclusion and appears to make it acceptable. However, alternative devices or materials can be readily designed for use in a consumable product. Fine sand particles with less sharp cleavage boundaries come to mind. Unreactive stainless steel wool exhibiting many small size wires with sharp edges is another possible alternative.

### Application to Spirits

Although the concentration of alcohol is many times higher in spiritous beverages such as whiskey, the chemical milieu is similar and there is no reason to question that the fundamental chemical reaction dynamics would not happen in a similar fashion as described above for wine during the aging process. The fact that this aging can last for as long as 5 years for even an inexpensive barrel aged bourbon suggest that lower dosages are also possible. This could lead to a barrel aged whiskey with aging characteristics in a foreshortened time.

### Embodiments for Wine

This effect can be produced in several different SRI embodiments. These sharp edges can be introduced on the interior surface of the bottle, on the interior face of the closure, by the introduction of micro particles into the wine, and by a plastic or ceramic object (rod, disc, tube or sphere as an example) with manufactured sharp edges or points.

It is also apparent that this treatment can also be used to “age” wines in bulk. The latter would present a significant quality improvement at a low cost and is more financially attractive than similar aging in bottles. As an example, this can be accomplished by simply adding crushed glass to the final vat before bottling where chemical activity can happen in an essentially quiescent state.

### Embodiments for Spirits

Addressing only barrel aging, in its simplest form, introduce and remove the SRI through the bung hole of the barrel. It will then set there for the duration of aging process passively performing its function while the aging products diffuse slowly into the body of the liquor. The barrel will be emptied through a sieve sufficiently small to retain the SRI.

The foregoing is only the preferable embodiment of the present invention, and is not used for limiting the present invention. Any modification, equivalent substitution and improvement made within the spirit and principle of the present invention shall fall within the protection scope of the present invention.

What is claimed is:

1. A process for treating new wines in bulk before bottling leading to acceleration of native chemical reactions occurring during aging comprised of the introduction of SRI into the new wine and holding for a period of at least 3 months.

2. A treatment as in claim 1 where the SRI is crushed glass smaller than 2 mm. sieve size at a rate more than 10 g/L for a period of greater than 3 months.

3. A treatment as in claim 2 where the SRI is crushed quartz rather than crushed glass.

4. A treatment as in claim 1 where the SRI is stainless steel wool composed of fibers smaller than a nominal 5 mm and at a rate of more than 6 g/L of new wine for a period greater than 3 months.

5. A process for treating new wine in bulk prior to bottling leading to acceleration of native chemical reactions occurring during vinification comprising the introduction of SRI at a rate of at least 12 g/L into the young wine for a period of at least 3 months.

6. A process for treating spirits aged in barrels comprising introducing SRI at a rate of at least into the barrel during the aging process.

7. A process as in claim 6 where the SRI is crushed glass that will pass at least a 2 mm. sieve and is applied at a rate of at least 5 gm/L for the duration of aging.
